(19) United States
(12) Patent Application Publication
(10) Pub. No.: US 2014/0009122 A1
(43) Pub. Date: Jan. 9, 2014

(54) APPARATUS AND METHOD FOR CHARGING A LITHIUM BATTERY

(71) Applicant: Se Ho Lo, Gyeonggi-do (KR)

(72) Inventor: Se Ho Lo, Gyeonggi-do (KR)

(21) Appl. No.: 14/005,769

(22) PCT Filed: Jun. 3, 2011
(86) PCT No.: PCT/KR11/04086

§ 371 Date: Sep. 17, 2013

(30) Foreign Application Priority Data
Mar. 23, 2011 (KR) 10-2011-0025604

(51) Int. Cl. H02J 7/00

(52) U.S. Cl. CPC H02J 7/007
USPC 320/152

(57) ABSTRACT

The present invention relates to an apparatus and method for charging a lithium battery. According to one embodiment of the present invention, an apparatus for charging a lithium battery comprises: a lithium battery; a temperature sensor detecting the temperature of the lithium battery; a voltage detection unit detecting the voltage of the lithium battery; a central processing unit using the detected temperature of the lithium battery to determine the boost charging start voltage, which is a reference for starting the boost charging of the lithium battery, and to determine the pulse charging start voltage, which is a reference for starting the pulse charging of the lithium battery, and comparing the determined pulse charging start voltage with the detected voltage of the lithium battery so as to generate a pulse charging signal, a boost charging signal, or a multilevel constant current charging signal according to the result of the comparison; and a charging power control unit for charging the lithium battery through a pulse charging, boost charging, or multilevel constant current charging method according to the pulse charging signal, the boost charging signal, or the multilevel constant current charging signal.

### CROSS-REFERENCE TO RELATED APPLICATION

This application claims the benefit of Korean Patent Application No. 10-2011-0025604, filed on Mar. 23, 2011 in the Korean Intellectual Property Office, the disclosure of which is incorporated herein by reference.

### TECHNICAL FIELD

The present invention relates to an apparatus and method for charging a lithium battery, and more particularly, to a technology of charging a lithium battery in consideration of a temperature and a voltage of the lithium battery.

### BACKGROUND ART

As a mode for charging a lithium battery, a constant current-constant voltage charging mode has been frequently used.

The constant current-constant voltage charging mode is a mode in which the lithium battery is charged in a constant current mode, and when a voltage of the lithium battery reaches an upper limit voltage of the lithium battery, for example, 4.1 V to 4.2 V, a charging mode of the lithium battery is changed to a constant voltage charging mode to charge the lithium battery at a low current so as not to allow the voltage of the lithium battery to exceed the upper limit voltage.

There is an advantage that the constant current-constant voltage charging mode is convenient and easy to be realized.

Unfortunately, when the lithium battery is charge in the constant current-constant voltage charging mode, that is, when only a charging current increases, since there is a limit to a charging time to be shortened, there is a problem that as the lithium battery is charged at a high current, a lifespan of the lithium battery is quickly shortened.

Further, when the lithium battery is charged at a low-temperature state, the lifespan of the lithium battery is shortened and a buffering capacity is reduced. Especially, since lithium plating is merely performed at 20 degrees below zero temperatures, there is a problem that the lithium battery is not charged in the constant current charging mode.

### DISCLOSURE

### Technical Problem

An object of the present invention is to provide an apparatus and method for charging a lithium battery with which it is possible to charge a lithium battery at a high speed while maintaining a charging capacity of the lithium battery even at a low temperature and to extend a lifespan of the lithium battery at the time of charging the lithium battery at a high current.

### Technical Solution

An exemplary embodiment of the present invention provides a method for charging a lithium battery including detecting a temperature of a lithium battery by using a temperature sensor; determining a boost charging start voltage which is a reference for starting boost charging of the lithium battery and a pulse charging start voltage which is a reference for starting pulse charging of the lithium battery by using the detected temperature of the lithium battery; comparing the detected voltage of the lithium battery with the determined pulse charging start voltage; charging the lithium battery in a pulse charging mode when the detected voltage of the lithium battery is higher than the determined pulse charging start voltage, comparing the detected voltage of the lithium battery with the determined boost charging start voltage when the detected voltage of the lithium battery is lower than the determined pulse charging start voltage, charging the lithium battery in a boost charging mode when the detected voltage of the lithium battery is lower than the determined boost charging start voltage, and charging the lithium battery in a multilevel constant current charging mode when the detected voltage of the lithium battery is higher than the determined boost charging start voltage; determining whether or not the voltage of the lithium battery charged in the pulse charging mode, the boost charging mode or the multilevel constant current charging mode reaches a full charging voltage of the lithium battery; determining whether or not the lithium battery is not charged in the pulse charging mode when the voltage of the lithium battery reaches the full charging voltage of the lithium battery; and determining whether or not a charging current of the lithium battery is higher than a reference charging current at the time of reaching the full charging voltage of the lithium battery when the lithium battery is not charged in the pulse charging mode, decreasing the charging current of the lithium battery higher than the reference charging current by one level to charge the lithium battery in the multilevel constant current charging mode when the charging current is higher than the reference charging current, stopping the charging of the lithium battery when the charging current is lower than the reference charging current, changing a charging mode of the lithium battery to the multilevel constant current charging mode to charge the lithium battery when the lithium battery is charged in the pulse charging mode.

The pulse charging start voltage may be calculated using the detected temperature of the lithium battery, a minimum voltage of the lithium battery, and the full charging voltage of the lithium battery.

The pulse charging start voltage may be calculated using the following equation.

$$pulse charging start voltage = \{ \begin{matrix}\begin{matrix}( full charging voltage - A ) \cdot ( \frac{first temperature - detected battery temperature}{B} ) \\ detected battery temperature \leq first temperature\end{matrix} , \\ full charging voltage \cdot ( \frac{second temperature - detected battery temperature}{C} ) , \\ first temperature < detected battery temperature \leq second temperature \\ full charging voltage , detected battery temperature > second temperature\end{matrix} \qquad [ Equation ]$$

where A, B, and C are different constants from each other, and a first temperature is lower than a second temperature.

The boost charging start voltage may be calculated using the detected voltage of the lithium battery and the full charging voltage.

The boost charging start voltage may be calculated using the following equation.

$$boost charging start voltage = full charging voltage - ( \frac{detected battery temperature}{D} ) \qquad [ Equation ]$$

where D is a constant.

When the lithium battery is charged in the boost charging mode, it may be determined whether or not the voltage of the lithium battery charged in the boost charging mode is higher than a boost-charging stop reference voltage, and it may be determined whether or not the voltage of the lithium battery charged in the boost charging mode reaches the full charging voltage of the lithium battery when the voltage of the lithium battery charged in the boost charging mode is higher than the boost-charging stop reference voltage.

Exemplary embodiment of the present invention also provides an apparatus for charging a lithium battery including a lithium battery; a temperature sensor that detects a temperature of the lithium battery; a voltage detection unit that detects a voltage of the lithium battery; a central processing unit that determines a boost charging start voltage which is a reference for starting boost charging of the lithium battery and a pulse charging start voltage which is a reference for starting pulse charging of the lithium battery by using the detected temperature of the lithium battery, compares the determined pulse charging start voltage with the detected voltage of the lithium battery, and generates a pulse charging signal, a boost charging signal or a multilevel constant current charging signal depending on the comparison result; and a charging power control unit that charges the lithium battery in a pulse charging mode, a boost charging mode or a multilevel constant current charging mode in response to the pulse charging signal, the boost charging signal or the multilevel constant current charging signal.

The central processing unit may calculate the pulse charging start voltage by using the detected temperature of the lithium battery, a minimum voltage of the lithium battery, and a full charging voltage of the lithium battery.

The central processing unit may calculate the boost charging start voltage by using the full charging voltage and the detected voltage of the lithium battery.

The central processing unit may generate the pulse charging signal when the detected voltage of the lithium battery is higher than the determined pulse charging start voltage, compares the detected voltage of the lithium battery with the determined boost charging start voltage when the detected voltage of the lithium battery is lower than the determined pulse charging start voltage, generate the boost charging signal when the detected voltage of the lithium battery is lower than the determined boost charging start voltage, and generate the multilevel constant current charging signal when the detected voltage of the lithium battery is higher than the determined boost charging start voltage.

The central processing unit may determine whether or not the voltage of the lithium battery charged in the pulse charging mode, the boost charging mode or the multilevel constant current charging mode reaches the full charging voltage of the lithium battery, determine whether or not the lithium battery is charged in the pulse charging mode by the charging power control unit when the voltage of the lithium battery reaches the full charging voltage, determines whether or not a charging current of the lithium battery is higher than a reference charging current at the time of reaching the full charging voltage of the lithium battery when the lithium battery is not charged in the pulse charging mode, control the charging power control unit to decrease the charging current of the lithium battery higher than the reference charging current by one level and to charge the lithium battery in the multilevel constant current charging mode when the charging current is higher than the reference charging current, controls the charging power control unit to stop the charging of the lithium battery when the charging current is higher than the reference charging current, and control the charging power control unit to change a charging mode of the lithium battery to the multilevel constant current charging mode and to charge the lithium battery when the lithium battery is charged in the pulse charging mode.

The central processing unit may determine whether or not the voltage of the lithium battery charged in the boost charging mode is higher than a boost-charging stop reference voltage when the lithium battery is charged in the boost charging mode, and determine whether or not the voltage of the lithium battery charged in the boost charging mode reaches the full charging voltage of the lithium battery when the voltage of the lithium battery charged in the boost charging mode is higher than the boost-charging stop reference voltage.

The apparatus for charging a lithium battery may further include a lithium-battery current detection unit that detects the charging current of the lithium battery and feeds the detected charging current back to the central processing unit.

### Effect of the Invention

According to an apparatus and method for charging a lithium battery according to an embodiment of the present invention, a boost charging start voltage which is a reference for starting boost charging of a lithium battery and a pulse charging start voltage which is a reference for starting pulse charging of the lithium battery are determined depending on a temperature of the lithium battery, the determined pulse charging start voltage and the detected voltage of the lithium battery are compared from each other, and the lithium battery is charged in a pulse charging mode, a boost charging mode or a multilevel constant current charging mode depending on the comparison result. In this way, it is possible to charge the lithium battery at a high speed while maintaining a charging capacity of the lithium battery even at a low temperature and to extend a lifespan of the lithium battery at the time of charging the lithium battery at a high current.

### DESCRIPTION OF DRAWINGS

FIG. 1 is a diagram illustrating a configuration of an apparatus for charging a lithium battery according to an embodiment of the present invention.

FIG. 2 is a diagram illustrating a flowchart of a method for charging a lithium battery according to an embodiment of the present invention.

### BEST MODE

Hereinafter, embodiments of the present invention will be described with reference to the accompanying drawings. In the description of the embodiments of the present invention, when it is determined that detailed descriptions of known functions or configurations related to the present invention would obscure the gist of the present invention, the descriptions thereof will not be presented. Further, terms to be described herein are defined by considering their functions in the present invention, and may be variable depending on the intention of a user or an operator or according to practice. Therefore, those terms should be defined in light of the entire context of the specification.

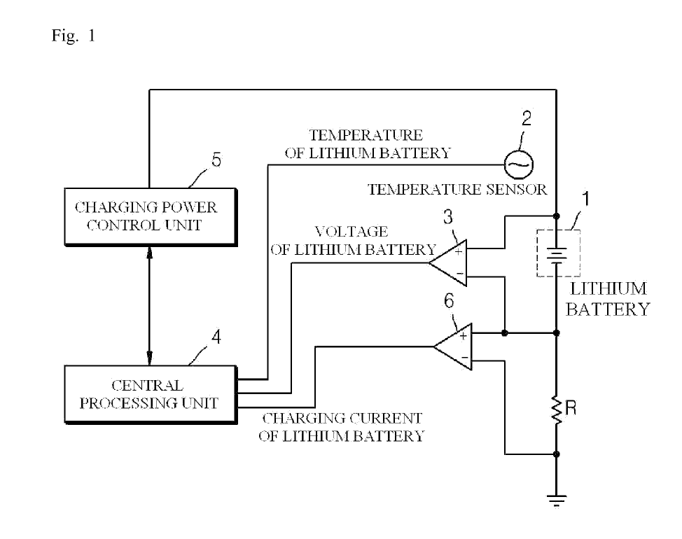

FIG. 1 is a diagram illustrating a configuration of an apparatus for charging a lithium battery according to an embodiment of the present invention.

As shown in the drawing, the apparatus for charging a lithium battery according to the embodiment of the present invention includes a lithium battery 1, a temperature sensor 2, a voltage detection unit 3, a central processing unit 4, and a charging power control unit 5. Here, the lithium battery 1 may be a lithium ion battery.

The temperature sensor 2 detects a temperature of the lithium battery and provides the detected temperature to the central processing unit 4.

The voltage detection unit 3 detects a voltage of the lithium battery and provides the detected voltage to the central processing unit 4. Here, the voltage detection unit may be configured to include an OP-AMP.

The central processing unit 4 determines a boost charging start voltage which is a reference for starting boost charging of the lithium battery and a pulse charging start voltage which is a reference for starting pulse charging of the lithium battery by using the temperature of the lithium battery detected by the temperature sensor 2.

At this time, the central processing unit 4 may calculate the pulse charging start voltage by using the detected temperature of the lithium battery, a minimum voltage of the lithium battery and a full charging voltage of the lithium battery. The minimum voltage of the lithium battery represents a minimum voltage at which the lithium battery can be charged, but the lithium battery is not charged at the minimum voltage of the lithium battery. In the embodiment, the pulse charging start voltage can be calculated by using the following equation 1. The minimum voltage of the lithium battery represents the minimum voltage at which the lithium battery can be charged. Namely, the lithium battery is not charged at a level equal to or less than the minimum voltage of the lithium battery.

$$pulse charging start voltage = \{ \begin{matrix}\begin{matrix}( full charging voltage - A ) \cdot ( \frac{first temperature - detected battery temperature}{B} ) \\ detected battery temperature \leq first temperature\end{matrix} , \\ full charging voltage \cdot ( \frac{second temperature - detected battery temperature}{C} ) , \\ first temperature < detected battery temperature \leq second temperature \\ full charging voltage , detected battery temperature > second temperature\end{matrix} \qquad [ Equation 1 ]$$

where A, B, and C are different constants, and a first temperature is lower than a second temperature.

In the embodiment, the first temperature may be 23 degrees Celsius, and the second temperature may be 30 degrees Celsius.

As can be seen from the above-mentioned equation 1, as the detected temperature of the lithium battery decreases, a temperature section in which the pulse charging is performed is increased, and when the detected temperature of the lithium battery is below zero temperatures, the temperature section in which the pulse charging is performed becomes 100%. Further, as the detected temperature of the lithium battery increases, the temperature section in which the pulse charging is performed is gradually decreased, and when the detected temperature of the lithium battery exceeds the second temperature, the pulse charging section becomes 0%. Thus, the pulse charging is not performed.

Further, the central processing unit 4 can calculate the boost charging start voltage by using the detected voltage of the lithium battery and the full charged voltage. In the embodiment, the boost charging start voltage can be calculated using the following equation 2.

$$boost charging start voltage = full charging voltage - ( \frac{detected battery temperature}{D} ) \qquad [ Equation 2 ]$$

where D is a constant.

Thereafter, the central processing unit 4 compares the determined pulse charging start voltage with the voltage of the lithium battery detected by the voltage detection unit 3, and generates a pulse charging signal, a boost charging signal or a multilevel constant current charging signal depending on the comparison result. Here, the pulse charging signal may include a PWM output for adjusting a charging current of the lithium battery and a bit signal for starting the pulse charging, and the boost charging signal may include a PWM output for adjusting a charging current of the lithium battery and a bit signal for starting the boost charging. Further, the multilevel constant current charging signal may include a PWM output for adjusting a charging current of the lithium battery and a bit signal for starting multilevel constant current charging. Furthermore, ON-OFF ratios of the PWM outputs that are respectively included in the pulse charging signal, the boost charging signal, or the multilevel constant current charging signal may be different from each other. Here, the bit signal for starting the pulse charging may be first provided to the charging power control unit 4, and then the PWM output included in the pulse charging signal may be provided thereto. The two signals are continuously provided thereto until the charging is finished.

The generation of the pulse charging signal, the boost charging signal or the multilevel constant current charging signal will be described below.

The central processing unit 4 generates the pulse charging signal when the voltage of the lithium battery detected by the voltage detection unit 3 is higher than the determined pulse charging start voltage, and compares the voltage of the lithium battery detected by the voltage detection unit 3 with the determined boost charging start voltage when the detected voltage of the lithium battery is lower than the determined pulse charging start voltage. When the voltage of the lithium battery detected by the voltage detection unit 4 is lower than the determined boost charging start voltage, the central processing unit 4 may generate the boost charging signal, and when the detected voltage of the lithium battery is higher than the determined boost charging start voltage, the central processing unit may generate the multilevel constant current charging signal.

Subsequently, the central processing unit 4 determines whether or not the voltage of the lithium battery charged in the pulse charging mode, the boost charging mode or the multilevel constant current charging mode reaches the full charging voltage of the lithium battery. When it is determined that the voltage of the lithium battery reaches the full charging voltage, the central processing unit 4 determines whether or not the lithium battery is charged in the pulse charging mode by the charging power control unit 5. In addition, when the lithium battery 1 is charged in the boost charging mode, the central processing unit 4 determines whether or not the voltage of the lithium battery charged in the boost charging mode is higher than a boost charging stop reference voltage. When the voltage of the lithium battery charged in the boost charging mode is higher than the boost charging stop reference voltage, the central processing unit 4 may determine whether or not the voltage of the lithium battery charged in the boost charging mode reaches the full charging voltage of the lithium battery. At this time, the voltage of the lithium battery charged in the pulse charging mode, the boost charging mode or the multilevel constant current charging mode may be detected by the voltage detection unit 3 and may be provided to the central processing unit 4.

When the lithium battery 1 is not charged in the pulse charging mode, the central processing unit 4 compares the charging current of the lithium battery 1 with a reference charging current at the time of reaching the full charging voltage of the lithium battery 1. As the comparison result, when the charging current is higher than the reference charging current, the central processing unit decreases the charging current of the lithium battery higher than the reference charging current by one level and controls the charging power control unit 5 to allow the lithium battery to be charged in the multilevel constant current charging mode. Meanwhile, as the comparison result, when the charging current is lower than the reference charging current, the central processing unit controls the charging power control unit 5 to allow the charging of the lithium battery 1 to be stopped.

At this time, the multilevel constant current charging mode is a mode for charging the lithium battery by using a current that decreases in a step shape (a graph in which x-axis represents a time and y-axis represents a current) by dividing the charging current by a preset number of levels unlike the conventional charging current in which a value is linearly decreased. To achieve this, it is required to set the charging current, and a user may set the charging current by an input device (not shown).

The central processing unit 4 allows the lithium battery to be charged by dividing the set charging current by the preset number of levels, and when the voltage of the lithium battery reaches the full charging voltage and the pulse charging is not performed, the central processing unit decreases the charging current higher than the reference charging current at the time of reaching the full charging voltage by one level to allow the lithium battery to be charged. In the embodiment, when the charging current set by the user through the input device is 5 [A], the charging current is divided into five levels of 1 [A] to 5 [A], and thus the charging of the lithium battery is controlled at the charging current of 5 [A]. When the voltage of the lithium battery reaches the full charging voltage and the pulse charging is not performed, that is, when the charging current (5 [A]) of the lithium battery is higher than the reference charging current (1 [A]), it is possible to charge the lithium battery at the charging current of 4 [A] which is decreased from 5 [A] by one level.

At this time, the apparatus for charging a lithium battery according to the embodiment of the present invention may further include a lithium-battery current detection unit that detects the charging current of the lithium battery 1 and feeds the detected charging current back to the central processing unit 4.

Meanwhile, when the lithium battery is charged in the pulse charging mode, the central processing unit 4 can control the charging power control unit 5 to change the charging mode of the lithium battery 1 to the multilevel constant current charging mode and to charge the lithium battery 1.

The charging power control unit 5 charges the lithium battery 1 by using a voltage applied from the outside in the pulse charging mode, the boost charging mode or the multilevel constant current charging mode in response to the pulse charging signal, the boost charging signal or the multilevel constant current charging signal that are generated by the central processing unit 4. Here, a level of the voltage applied from the outside may be 12 V.

Namely, the charging power control unit 5 starts to charge the lithium battery 1 by using the pulse charging mode in response to the bit signal for starting the pulse charging included in the pulse charging signal. At this time, the charging power control unit 5 may determine the charging current of the lithium battery 1 on the basis of the ON-OFF ratio of the PWM included in the pulse charging signal. Further, the charging power control unit 5 starts to charge the lithium battery 1 by using the boost charging mode in response to the bit signal for stating the boost charging included in the boost charging signal. At this time, the charging power control unit 5 may determine the charging current of the lithium battery 1 on the basis of the ON-OFF ratio of the PWM included in the boost charging signal. Furthermore, the charging power control unit 5 starts to charge the lithium battery 1 by using the multilevel constant current charging mode in response to the bit signal for starting the multilevel constant current charging included in the multilevel constant current charging signal. At this time, the charging power control unit 5 may determine the charging current of the lithium battery 1 on the basis of the ON-OFF ratio of the PWM included in the multilevel constant current charging signal.

The pulse charging mode, the boost charging mode, and the multilevel constant current charging mode will be described below.

The pulse charging mode is a charging mode using a pulsed voltage and a pulsed current having various magnitudes and intervals, and is a mode capable of charging about 80% of a capacity of the lithium battery through the pulse charging instead of a constant voltage charging mode of a constant current-constant voltage charging mode. There is an advantage that the lithium battery in the pulse charging mode has can be charged more than about three times a charging capacity of the lithium battery in the constant current-constant voltage charging mode at a low temperature, for example, zero degrees Celsius. However, there is a disadvantage that a charging rate is slower than that in the constant current-constant voltage charging mode.

The boost charging mode is a mode capable of charging the lithium battery that has been almost discharged in a very short time at a high current. There is an advantage that a charging time of the lithium battery having a very small amount of charging is shortened in the boost charging mode. However, when the lithium battery is charged in the boost charging mode, there is a disadvantage that a lifespan of the lithium battery is quickly shortened and a buffering capacity is decreased at a low temperature.

The multilevel constant current charging mode is a mode for charging the lithium battery while decreasing the current value from a high current to a low current one level by one level. Thus, the multilevel constant current charging mode in the apparatus for charging a lithium battery according to the embodiment of the present invention may be a mode for charging the lithium battery while decreasing the current value from the high current to the low current one level by one level. There is an advantage that a lifespan of the lithium battery in the multilevel constant current charging mode has can be improved about 25% as compared with the constant current-constant voltage charging mode. However, there is a disadvantage that the charging is easily performed at a low temperature in the multilevel constant current charging mode.

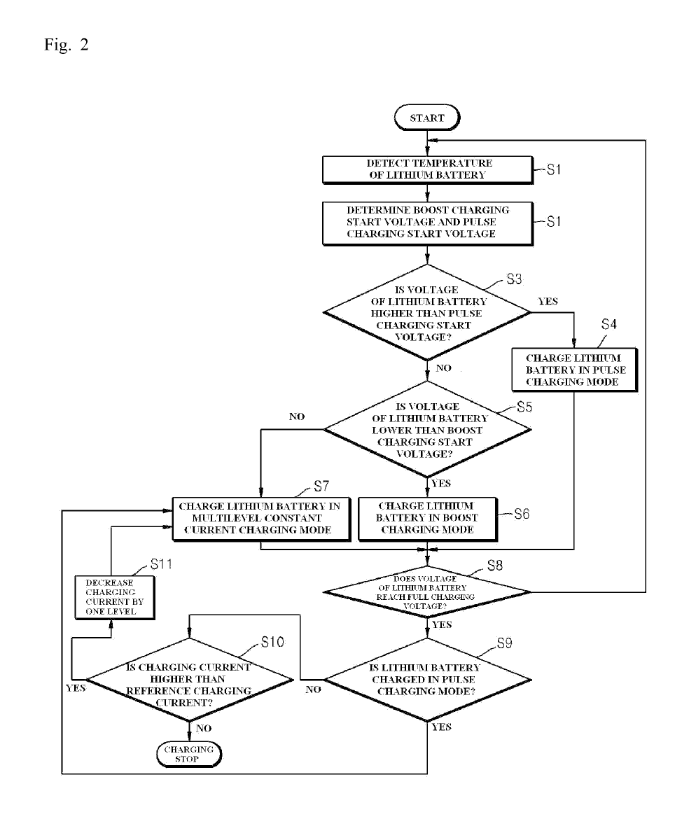

FIG. 2 is a flowchart illustrating a method for charging a lithium battery according to an embodiment of the present invention. The method for charging a lithium battery shown in FIG. 2 may be carried out by the apparatus for charging a lithium battery according to the embodiment of the present invention shown in FIG. 1.

As shown in the drawing, the apparatus for charging a lithium battery detects a temperature of the lithium battery by using a temperature sensor (S1).

The apparatus for charging a lithium battery determines a boost charging start voltage which is a reference for starting boost charging of the lithium battery and a pulse charging start voltage which is a reference for starting pulse charging of the lithium battery by using the detected temperature of the lithium battery (S2).

At this time, the pulse charging start voltage and the boost charging start voltage may be calculated using the equations 1 and 2, respectively.

The apparatus for charging a lithium battery compares a voltage of the lithium battery with the determined pulse charging start voltage (S3).

When the voltage of the lithium battery is higher than the determined pulse charging start voltage, the apparatus for charging a lithium battery charges the lithium battery in the pulse charging mode (S4). When the voltage of the lithium battery is lower than the determined pulse charging start voltage, the apparatus for charging a lithium battery compares the voltage of the lithium battery with the determined boost charging start voltage (S5). As the comparison result, when the voltage of the lithium battery is lower than the determined boost charging start voltage, the apparatus for charging a lithium battery charges the lithium battery in the boost charging mode (S6). Meanwhile, as the comparison result, when the voltage of the lithium battery is higher than the determined boost charging start voltage, the apparatus for charging a lithium battery charges the lithium battery in the multilevel constant current charging mode (S7). At this time, when the lithium battery is charged in the boost charging mode, the apparatus for charging a lithium battery may determine whether or not the voltage of the lithium battery charged in the boost charging mode is higher than a boost-charging stop reference voltage. When the voltage of the lithium battery charged in the boost charging mode is higher than the boost-charging stop reference voltage, the apparatus for charging a lithium battery may determine whether or not the voltage of the lithium battery charged in the boost charging mode reaches the full charging voltage of the lithium battery.

Thereafter, the apparatus for charging a lithium battery determines whether or not the voltage of the lithium battery charged in the pulse charging mode, the boost charging mode or the multilevel constant current charging mode reaches the full charging voltage of the lithium battery (S8).

When it is determined that the voltage of the lithium battery reaches the full charging voltage, the apparatus for charging a lithium battery determines whether or not the lithium battery is charged in the pulse charging mode (S9).

As the determination result, when the lithium battery is not charged in the pulse charging mode, the apparatus for charging a lithium battery determines whether or not a charging current of the lithium battery is higher than a reference charging current at the time of reaching the full charging voltage of the lithium battery (S10). When it is determined that the charging current is higher than the reference charging current, the apparatus for charging a lithium battery decreases the charging current of the lithium battery higher than the reference charging current by one level (S11) to charge the lithium battery in the multilevel constant current charging mode (S7).

Meanwhile, as the determination result of S9, when the lithium battery is charged in the pulse charging mode, the apparatus for charging a lithium battery proceeds to S7, and changes the charging mode of the lithium battery to the multilevel constant current charging mode to charge the lithium battery.

The present invention has been described in connection with the embodiments. It will be appreciated by those of ordinary skill in the art that the present invention can be embodied in various forms without departing from essential characteristics thereof. Therefore, the disclosed embodiments are considered in all respects to be illustrative and not restrictive. Accordingly, the scope of the present invention is not limited to the embodiments, and the accompanying claims, and the scope of the present invention should be interpreted to embrace various modifications that fall within the scope of the claims and the equivalence thereof.

### INDUSTRIAL APPLICABILITY

The present invention is applicable to a field of manufacturing an apparatus for charging a lithium battery.

1. A method for charging a lithium battery comprising:
detecting a temperature of a lithium battery by using a temperature sensor;
determining a boost charging start voltage which is a reference for starting boost charging of the lithium battery and a pulse charging start voltage which is a reference for starting pulse charging of the lithium battery by using the detected temperature of the lithium battery;
comparing the detected voltage of the lithium battery with the determined pulse charging start voltage;
charging the lithium battery in a pulse charging mode when the detected voltage of the lithium battery is higher than the determined pulse charging start voltage, comparing the detected voltage of the lithium battery with the determined boost charging start voltage when the detected voltage of the lithium battery is lower than the determined pulse charging start voltage, charging the lithium battery in a boost charging mode when the detected voltage of the lithium battery is lower than the determined boost charging start voltage, and charging the lithium battery in a multilevel constant current charging mode when the detected voltage of the lithium battery is higher than the determined boost charging start voltage;
determining whether or not the voltage of the lithium battery charged in the pulse charging mode, the boost charging mode or the multilevel constant current charging mode reaches a full charging voltage of the lithium battery;
determining whether or not the lithium battery is not charged in the pulse charging mode when the voltage of the lithium battery reaches the full charging voltage of the lithium battery; and
determining whether or not a charging current of the lithium battery is higher than a reference charging current at the time of reaching the full charging voltage of the lithium battery when the lithium battery is not charged in the pulse charging mode, decreasing the charging current of the lithium battery higher than the reference charging current by one level to charge the lithium battery in the multilevel constant current charging mode when the charging current is higher than the reference charging current, stopping the charging of the lithium battery when the charging current is lower than the reference charging current, changing a charging mode of the lithium battery to the multilevel constant current charging mode to charge the lithium battery when the lithium battery is charged in the pulse charging mode.

2. The method for charging a lithium battery according to claim 1, wherein the pulse charging start voltage is calculated using the detected temperature of the lithium battery, a minimum voltage of the lithium battery, and the full charging voltage of the lithium battery.

3. The method for charging a lithium battery according to claim 2, wherein the pulse charging start voltage is calculated using the following equation.
$$pulse charging start voltage = \{ \begin{matrix}\begin{matrix}( full charging voltage - A ) \cdot ( \frac{first temperature - detected battery temperature}{B} ) \\ detected battery temperature \leq first temperature\end{matrix} , \\ full charging voltage \cdot ( \frac{second temperature - detected battery temperature}{C} ) , \\ first temperature < detected battery temperature \leq second temperature \\ full charging voltage , detected battery temperature > second temperature\end{matrix} \qquad [ Equation ]$$
where A, B, and C are different constants from each other, and a first temperature is lower than a second temperature.

4. The method for charging a lithium battery according to claim 1, wherein the boost charging start voltage is calculated using the detected voltage of the lithium battery and the full charging voltage.

5. The method for charging a lithium battery according to claim 4, wherein the boost charging start voltage is calculated using the following equation.
$$boost charging start voltage = full charging voltage - ( \frac{detected battery temperature}{D} ) \qquad [ Equation ]$$
where D is a constant.

6. The method for charging a lithium battery according to claim 1, wherein when the lithium battery is charged in the boost charging mode, it is determined whether or not the voltage of the lithium battery charged in the boost charging mode is higher than a boost-charging stop reference voltage, and it is determined whether or not the voltage of the lithium battery charged in the boost charging mode reaches the full charging voltage of the lithium battery when the voltage of the lithium battery charged in the boost charging mode is higher than the boost-charging stop reference voltage.

7. An apparatus for charging a lithium battery comprising:
a lithium battery;
a temperature sensor that detects a temperature of the lithium battery;
a voltage detection unit that detects a voltage of the lithium battery;
a central processing unit that determines a boost charging start voltage which is a reference for starting boost charging of the lithium battery and a pulse charging start voltage which is a reference for starting pulse charging of the lithium battery by using the detected temperature of the lithium battery, compares the determined pulse charging start voltage with the detected voltage of the lithium battery, and generates a pulse charging signal, a boost charging signal or a multilevel constant current charging signal depending on the comparison result; and
a charging power control unit that charges the lithium battery in a pulse charging mode, a boost charging mode or a multilevel constant current charging mode in response to the pulse charging signal, the boost charging signal or the multilevel constant current charging signal.

8. The apparatus for charging a lithium battery according to claim 7, wherein the central processing unit calculates the pulse charging start voltage by using the detected temperature of the lithium battery, a minimum voltage of the lithium battery, and a full charging voltage of the lithium battery.

9. The apparatus for charging a lithium battery according to claim 8, wherein the central processing unit calculates the pulse charging start voltage by using the following equation.
$$pulse charging start voltage = \{ \begin{matrix}\begin{matrix}( full charging voltage - A ) \cdot ( \frac{first temperature - detected battery temperature}{B} ) \\ detected battery temperature \leq first temperature\end{matrix} , \\ full charging voltage \cdot ( \frac{second temperature - detected battery temperature}{C} ) , \\ first temperature < detected battery temperature \leq second temperature \\ full charging voltage , detected battery temperature > second temperature\end{matrix} \qquad [ Equation ]$$
where A, B, and C are different constants from each other, and a first temperature is lower than a second temperature.

10. The apparatus for charging a lithium battery according to claim 7, wherein the central processing unit calculates the boost charging start voltage by using the full charging voltage and the detected voltage of the lithium battery.

11. The apparatus for charging a lithium battery according to claim 10, wherein the central processing unit calculates the boost charging start voltage by using the following equation.
$$boost charging start voltage = full charging voltage - ( \frac{detected battery temperature}{D} ) \qquad [ Equation ]$$
where D is a constant.

12. The apparatus for charging a lithium battery according to claim 7, wherein the central processing unit generates the pulse charging signal when the detected voltage of the lithium battery is higher than the determined pulse charging start voltage, compares the detected voltage of the lithium battery with the determined boost charging start voltage when the detected voltage of the lithium battery is lower than the determined pulse charging start voltage, generates the boost charging signal when the detected voltage of the lithium battery is lower than the determined boost charging start voltage, and generates the multilevel constant current charging signal when the detected voltage of the lithium battery is higher than the determined boost charging start voltage.

13. The apparatus for charging a lithium battery according to claim 7, wherein the central processing unit determines whether or not the voltage of the lithium battery charged in the pulse charging mode, the boost charging mode or the multilevel constant current charging mode reaches the full charging voltage of the lithium battery, determines whether or not the lithium battery is charged in the pulse charging mode by the charging power control unit when the voltage of the lithium battery reaches the full charging voltage, determines whether or not a charging current of the lithium battery is higher than a reference charging current at the time of reaching the full charging voltage of the lithium battery when the lithium battery is not charged in the pulse charging mode, controls the charging power control unit to decrease the charging current of the lithium battery higher than the reference charging current by one level and to charge the lithium battery in the multilevel constant current charging mode when the charging current is higher than the reference charging current, controls the charging power control unit to stop the charging of the lithium battery when the charging current is higher than the reference charging current, and controls the charging power control unit to change a charging mode of the lithium battery to the multilevel constant current charging mode and to charge the lithium battery when the lithium battery is charged in the pulse charging mode.

14. The apparatus for charging a lithium battery according to claim 13, wherein the central processing unit determines whether or not the voltage of the lithium battery charged in the boost charging mode is higher than a boost-charging stop reference voltage when the lithium battery is charged in the boost charging mode, and determines whether or not the voltage of the lithium battery charged in the boost charging mode reaches the full charging voltage of the lithium battery when the voltage of the lithium battery charged in the boost charging mode is higher than the boost-charging stop reference voltage.

15. The apparatus for charging a lithium battery according to claim 13, further comprising:
a lithium-battery current detection unit that detects the charging current of the lithium battery and feeds the detected charging current back to the central processing unit.

16. The apparatus for charging a lithium battery according to claim 14, further comprising:
a lithium-battery current detection unit that detects the charging current of the lithium battery and feeds the detected charging current back to the central processing unit.

17. The apparatus for charging a lithium battery according to claim 8, wherein the central processing unit calculates the boost charging start voltage by using the full charging voltage and the detected voltage of the lithium battery.

18. The apparatus for charging a lithium battery according to claim 9, wherein the central processing unit calculates the boost charging start voltage by using the full charging voltage and the detected voltage of the lithium battery.

19. The method for charging a lithium battery according to claim 2, wherein the boost charging start voltage is calculated using the detected voltage of the lithium battery and the full charging voltage.

20. The method for charging a lithium battery according to claim 3, wherein the boost charging start voltage is calculated using the detected voltage of the lithium battery and the full charging voltage.
